(19) United States
(12) Patent Application Publication
(10) Pub. No.: US 2011/0199280 A1
(43) Pub. Date: Aug. 18, 2011

(54) DIELECTRIC ANTENNA COMPONENT, ANTENNA, AND METHODS

(76) Inventor: Pertti Nissinen, Kempede (FI)

(21) Appl. No.: 13/002,963

(22) PCT Filed: Jun. 17, 2009
(86) PCT No.: PCT/FI09/50533

§ 371 Date: Mar. 25, 2011

(30) Foreign Application Priority Data
Jul. 9, 2008 (FI) 20085715

(51) Int. Cl. H01Q 1/38; H01Q 7/00; H01Q 1/50

(52) U.S. Cl. 343/860; 343/866

(57) ABSTRACT

A dielectric antenna component (200) suitable for smallsized radio devices and an antenna based on such an antenna component. A substrate with relatively high permittivity for a radiating conductor is used in the antenna for reducing the size of the antenna. The substrate (210) is elongated, and the radiating conductive coating (220) constitutes a loop circulating via its ends. The width of one long side (221) of the loop is at most half of the width of the other long side (222). The bandwidth of a very small-sized antenna can be made large, because the phases of the electromagnetic waves in the radiator branches are nearly equal. For the same reason the efficiency of the antenna can be made relatively good in spite of the dielectric substrate.

The invention relates to a dielectric antenna component for implementing the antenna of small-sized radio devices and an antenna based on such an antenna component.

The internal antennas of the small-sized radio devices have mostly a planar structure so that they include a radiating plane parallel with the outer cover of the radio device and below the radiating plane a ground plane. The size of an antenna, i.e. the space it requires depends on the size of the radiator and the height of the antenna, or the distance of the radiator from the ground plane. For reducing a planar antenna its height can be arranged very small, but in this case a detrimental effect is the degrading of the electrical characteristics of the antenna. An internal antenna can also be of the monopole type, in which case it can be very flat. The electrical size of an antenna radiator is determined by its use frequency, irrespective of the antenna type. When keeping as a basis an air-insulated antenna, the physical size of the radiator and, at the same time, the size of the entire antenna can be reduced by means of a dielectric substrate. In this case, the radiator is a conductive coating of the substrate in question. However, in such an antenna, i.e. a dielectric antenna, the cost of the reduction of the antenna size is the increase in its losses and thus degrading of the efficiency.

In FIG. 1 there is an example of a known dielectric antenna. The antenna is of the monopole type. A part of the circuit board PCB of a radio device is seen in the drawing. On the upper surface of the circuit board, near its one end, there is an antenna component 100, which consists of a dielectric substrate 110 and a radiating element 120. The substrate is an elongated piece so that it has an upper and lower surface, a first and second side surface, and a first and second head surface. The lower surface lies against the circuit board PCB. The feed point FP of the antenna is in the corner of the lower surface of the substrate defined by the first side surface and the first head surface. The radiating element 120 has been implemented by coating a part of the substrate 110 with a conductive material. It comprises two consecutive portions. The first portion starts from the feed point FP and extends along the first side surface of the substrate to the second head surface. The second portion covers the most part of the upper surface of the substrate and extends near to the first head surface. The second portion can also extend to the side of the second side surface. On the circuit board PCB there is the ground plane GND required also by the function of the antenna. The edge of the ground plane is at a certain distance from the antenna component in the direction perpendicular to the longitudinal direction of the component. The feed conductor FC of the antenna is a conductive strip on the circuit board PCB, extending to the feed point FP. For matching the antenna impedance, a matching component 150 has been connected between the feed conductor and the ground GND, which component is here an inductive or capacitive chip component.

A drawback of the antennas like the one described above is, in addition to said dielectric losses, that their bandwidth remains insufficient when a broader band than usual is needed, for example the proportional bandwidth of 25 percent.

The object of the invention is to reduce said drawback relating to the prior art. The antenna component according to the invention is characterized in what is presented in the independent claim 1. Some advantageous embodiments of the invention are disclosed in the other claims.

The basic idea of the invention is as follows: In a dielectric antenna, A substrate with relatively high permittivity for a radiating conductor is used in the antenna for reducing the size of the antenna. The substrate is elongated, and the radiating conductive coating constitutes a loop circulating via its ends. The width of one long side of the loop is at most half of the width of the other long side.

An advantage of the invention is that the bandwidth of a very small-sized antenna can be made large compared to the corresponding known antennas. This is due to that the phases of the electromagnetic waves in the radiator branches are nearly equal. For the same reason the efficiency of the antenna can be made relatively good in spite of the dielectric substrate. A further advantage of the invention is that the production costs of the antenna components according to it are relatively low, and also the costs caused by their mounting in the production are low.

The invention will next be described in more detail referring to the enclosed drawings, in which

FIG. 1 shows an example of the dielectric antenna according to the prior art,

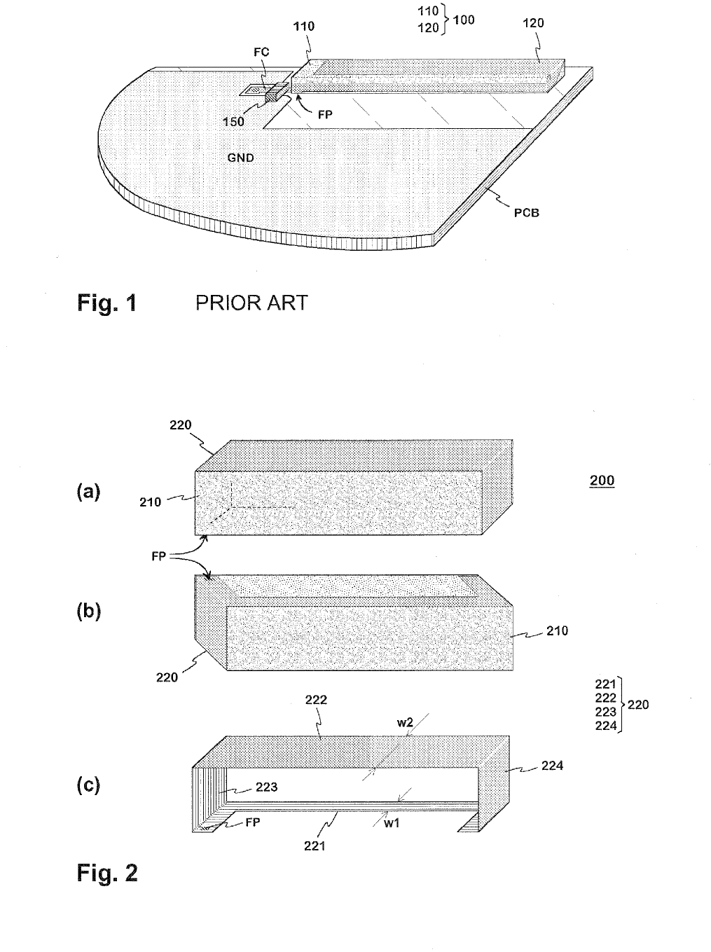

FIG. 2 shows an example of the antenna component according to the invention,

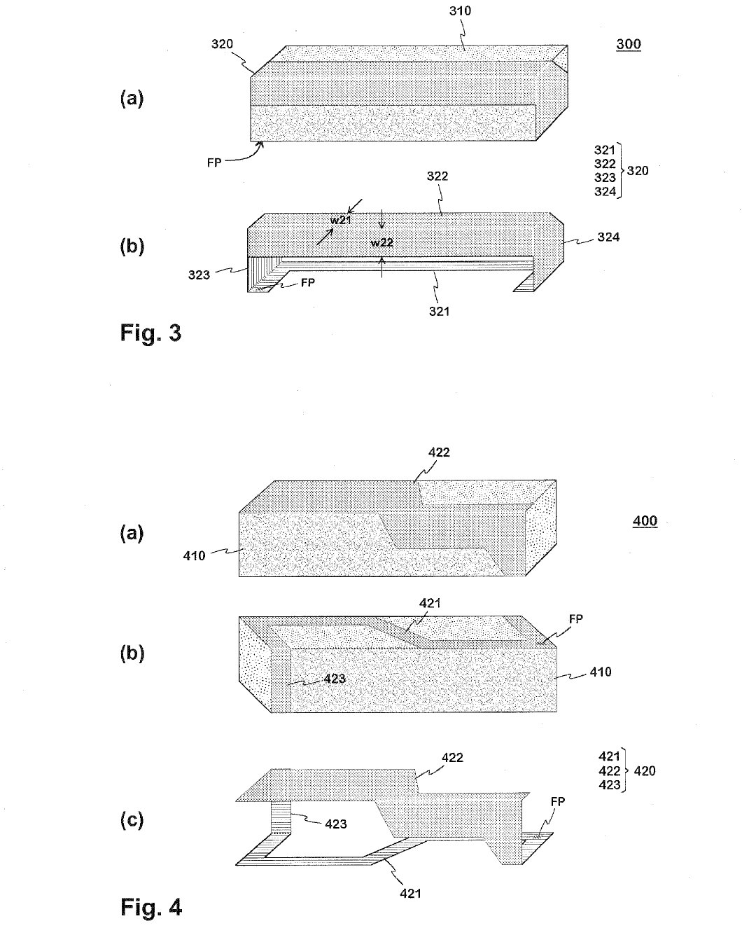

FIG. 3 shows a second example of the antenna component according to the invention,

FIG. 4 shows a third example of the antenna component according to the invention,

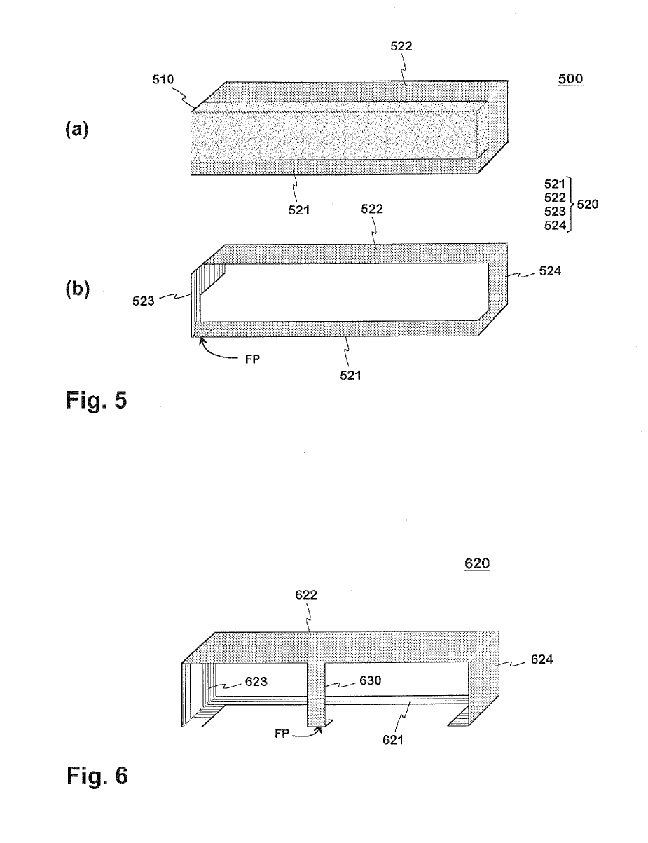

FIG. 5 shows a fourth example of the antenna component according to the invention,

FIG. 6 shows a fifth example of the antenna component according to the invention,

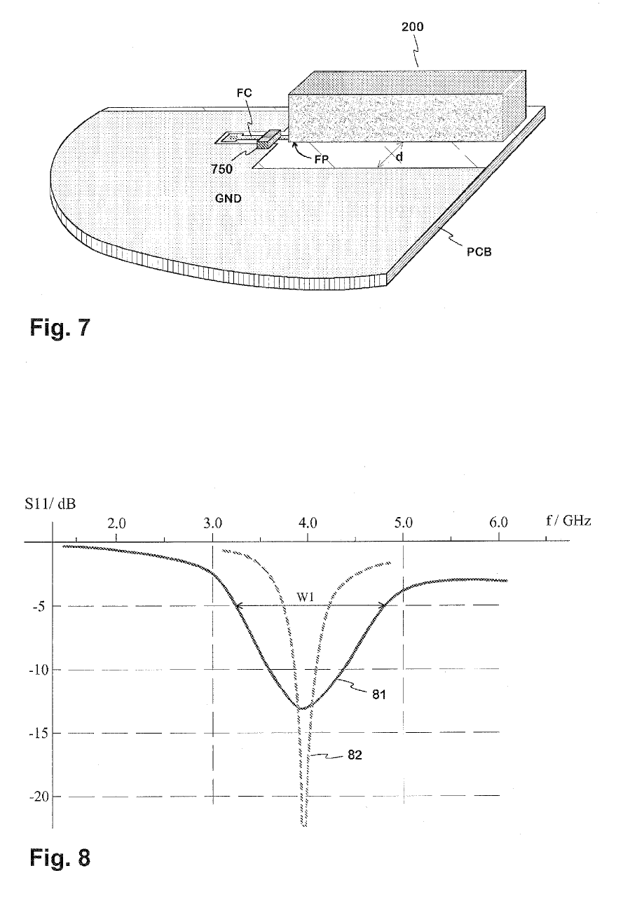

FIG. 7 shows an example of the dielectric antenna according to the invention,

FIG. 8 shows a example of the band characteristics of the antenna according to the invention, and

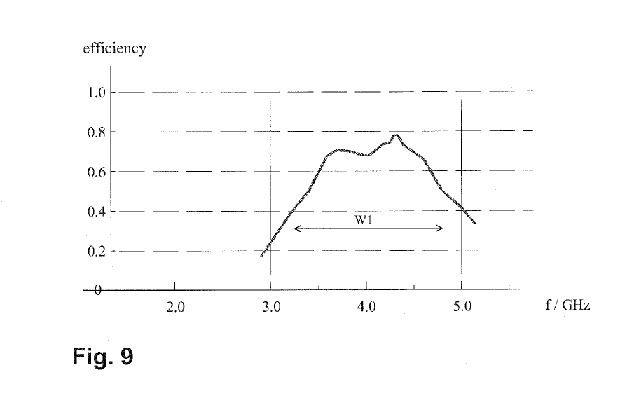

FIG. 9 shows an example of the efficiency of the antenna according to the invention.

FIG. 2 shows an example of the antenna component according to the invention. The antenna component 200 consists of a dielectric substrate 210 and a radiating element 220, which is of conductive coating of the substrate. The substrate is an elongated piece so that it has an upper and lower surface, a front and back surface and a first and second head surface. The partial figure (a) is a perspective drawing so that the upper surface, front surface and second head surface are visible of the antenna component 200. In the partial figure (b) the antenna component has been turned so that the lower surface, back surface and first head surface are visible of it. In the partial figure (c) the substrate has been removed, in which case the shape of the radiating element 220 is illustrative.

The radiating element is loop-like in accordance with the invention. The loop is constituted so that the radiating element comprises two portions with length substantially same as the length of the substrate, which portions are in galvanic connection to each other at both ends of the substrate. In this example the radiating element 220 comprises a first portion 221, which is located on the lower surface of the substrate and extends from the first head surface to the second head surface, and a second portion 222, which is located on the upper surface of the substrate and extends from the second head surface to the first head surface. In addition, the radiating element comprises a third portion 223, which covers a part of the first head surface and connects there together the first and second portion, and a fourth portion 224, which covers a part of the second head surface and connects there together the first and second portion.

Close to the both head surfaces the first portion 221 of the radiating element has the same width as the substrate, but along nearly the whole first portion its width w1 is significantly smaller. The second portion 222 covers in this example substantially wholly the upper surface of the substrate, its width w2 then being same as the width of the substrate. Such a difference between the widths of the portions of the radiator is substantial in the invention. In the example of FIG. 2 the width w1 of the first portion is about 30% of the width w2 of the second portion. More generally, the average width of the first portion is at most half of the average width of the second portion.

The feed point FP of the antenna made using the antenna component 200 is at the first end of the component, at the end of the first portion 221 near to the joining point of it and the third portion 223. The feed point could as well be located also at the second end of the component.

In this description and claims the “lower surface” of the substrate means its surface, which is against some planar surface of the radio device, when the antenna component has been mounted. The “upper surface” is naturally the opposite surface of the substrate in respect of the lower surface. The “vertical direction” means then the direction of the normal of the lower and upper surface. The “front surface” means one side surface between the lower and upper surface, and “back surface” the opposite surface in respect of the front surface. The “head surface” of the substrate means the surface, which is outermost in its longitudinal direction, and the “end” of an the substrate means its part which borders on its head surface and is relatively short compared to the length of the substrate. Thus for example the surface of the second end consists of the second head surface and a minor part of the lower, upper, front and back surfaces.

FIG. 3 shows a second example of the antenna component according to the invention. The partial figure (a) is a perspective drawing so that the upper surface, front surface and second head surface are visible of the antenna component 300, and in the partial figure (b) the substrate has been removed, in which case the shape of the radiating element 320 is illustrative. The antenna component 300 comprises an elongated substrate 310 and a loop-like radiating element as in FIG. 2. A remarkable difference in respect of the structure presented in FIG. 2 is that now the second portion 322 of the radiating element is only partly located on the upper surface of the substrate, the rest of the part being located on the front surface of the substrate. Both of these parts have the same length as the whole substrate. The total width of the second portion is the sum of the width w21 of its part on the upper surface and the width w22 of its part on the front surface. The first portion 321 of the radiating element is located at the edge of the lower surface of the substrate, on the side of the back surface as in FIG. 2. The third 323 and fourth 324 portion, which close the radiator loop, cover partly the head surfaces of the substrate

FIG. 4 shows a third example of the antenna component according to the invention. The partial figure (a) is a perspective drawing so that the upper surface, front surface and second head surface are visible of the antenna component 400. In the partial figure (b) the antenna component has been turned so that the lower surface, back surface and first head surface are visible of it. In the partial figure (c) the substrate has been removed, in which case the shape of the radiating element 420 is illustrative. The antenna component 400 comprises an elongated substrate 410 and a loop-like radiating element as in FIGS. 2 and 3. One difference in respect of the structure presented in FIG. 3 is that now only the part of the first portion 421 of the radiating element on the side of the second end of the substrate is located at the edge of the lower surface on the side of the back surface. After this part the first portion continues diagonally across the lower surface and then to the first end of the substrate at the edge of the lower surface on the side of the front surface. Starting from the first end, the second portion 422 of the radiating element is first located wholly on the upper surface of the substrate as wide as it. About halfway along the substrate the second portion 422 extends to the side of the front surface and at the same time its part on the upper surface narrows so that a strip at the edge on the side of the front surface remains of it, the strip extending to the second end of the substrate. Also the part of the second portion on the front surface continues to the second end and widens at the tail end as high as the substrate so that it extends to the level of the lower surface. At this point at the level of the lower surface the second portion joins the first portion 421, which is then as wide as the substrate at the second end. The third portion 423 of the radiating element is located on the back surface of the substrate at the first end. It extends from the level of the lower surface to the level of the upper surface thus connecting the first and second portions together.

The second portion of the radiating element can also extend to the back surface on the side of the first end and cover the upper surface only on the side of the back surface. The first and second portions are in this case shaped so that the segment of the line between them in the plane of the cross section of the component is oblique in respect of the vertical direction, excluding the centre of the component. Another difference to the structures presented in FIGS. 2 and 3 is that the radiating element 420 does not extend to the head surface of the substrate at either end. The head surfaces are then not at all coated by a conductor. In the example of FIG. 4 the feed point FP is located at the second end of the antenna component, in the corner of the lower surface confined by the second head surface and the back surface.

FIG. 5 shows a fourth example of the antenna component according to the invention. The partial figure (a) is a perspective drawing so that the upper surface, front surface and second head surface are visible of the antenna component 500, and in the partial figure (b) the substrate has been removed, in which case the shape of the radiating element 520 is illustrative. The radiating element is loop-like as also in the other embodiments. A difference in respect of the structures presented in FIGS. 2-4 is that the long portions of the radiating element are located only on two adjacent sides of the substrate 510: the first portion 521 is on the front surface of the substrate, in its lower part, and the second portion 522 is on the upper surface of the substrate, in its back part. The second portion is more than two times wider than the first portion. The radiating element further comprises the third portion 523, which covers partly the first head surface of the substrate and connects there the first and second portions together, and the fourth portion 524, which covers partly the second head surface of the substrate and connects there the first and second portions together. The feed point FP of the antenna made using the antenna component 500 is at the first end of the component, at the joining point of the first 521 and third 523 portions of the radiating element.

FIG. 6 shows a fifth example of the antenna component according to the invention. Only the radiating element 620 of it is visible in the figure. Thus the substrate, the conductor coating of which the radiating element is, is not shown. The radiating element comprises the first 621, second 622, third 623 and fourth 624 portions similarly as in FIG. 2. The difference in respect of the component presented in FIG. 2 is that the feed point FP is now located about the mid part of the antenna component instead of its end, at the edge of the lower surface of the substrate on the side of the front surface. A conductor strip 630 is on the front surface connecting the feed point FP to the second portion 622 of the radiating element on the upper surface. Naturally, the feed point can as well be located at the edge of the lower surface of the substrate on the side of the back surface, connected to the radiating element via the back surface. In this case the first portion of the radiating element would be located at the edge of the lower surface on the side of the front surface. Moreover, the feed point FP can be located about the mid part of the second portion 621 of the radiating element, in which case the conductor strip 630 seen in FIG. 6 is left out.

FIG. 7 shows an example of the dielectric antenna according to the invention. A part of the circuit board PCB of a radio device is seen in the drawing. On the circuit board PCB, in this example near to one corner of it, there is the antenna component, which is here like the antenna component 200 in FIG. 2. It is fastened to the circuit board from its lower surface. The fastening can be implemented e.g. by soldering, in which case there are conductive pads on the circuit board for the soldering. The fastening can be reinforced by adhesive material, when needed. The fastening can also be implemented by laminating, in which case the ceramic piece is pressed against the circuit board in a high temperature, until they have adhered to each other. The feed conductor FC of the antenna is a conductive strip on the circuit board PCB extending to the feed point FP under the antenna component. On the circuit board there is the ground plane GND required also by the antenna function. The edge of the ground plane is at a certain distance d from the antenna component in the direction perpendicular to its longitudinal direction. The distance d from the antenna affects the antenna characteristics, such as the bandwidth and impedance. In addition, there is a matching component 750 for matching the antenna impedance, which component has been connected between the feed conductor FC and the ground. The matching component is typically a chip component having a certain inductance or capacitance.

FIG. 8 shows an example of the band characteristics of the antenna according to the FIG. 7. The substrate of the antenna component is of ceramic, the dielectric coefficient of which is 35 and the dimensions are 7 mm·1.6 mm·1.6 mm. The matching component is a coil, the inductance of which is 1.5 nF. The antenna has been designed for the devices operating according to the UWB system (Ultra Wide Band), the frequency range of which begins from the frequency 3.1 GHz. Curve 81 shows the variation of the reflection coefficient 811 as the function of frequency. The smaller the reflection coefficient, the better the antenna has been matched and the better it functions as a radiator and receiver of the radiation. It is seen from the curve that the antenna has a quite wide band. When using e.g. the value −5 dB of the reflection coefficient as criterion for the border frequency, the bandwidth W1 will be more than 1.5 GHz, the proportional value being about 40%.

For comparison, curve 82 of the reflection coefficient of a corresponding usual monopole antenna is in FIG. 8. ‘Corresponding’ means that the substrate and arrangement on the circuit board is similar, but the radiator does not form a closed pattern on the substrate surface. It is seen from curve 82 that the bandwidth of the monopole antenna in question, using the above-mentioned criterion of −5 dB, is about 500 MHz, thus a third of the bandwidth of the antenna according to the invention.

FIG. 9 shows the efficiency of the antenna according to the invention, the reflection coefficient of which is in FIG. 8. The curve shows the efficiency in free space as the function of frequency. It is seen that in the band W1, which corresponds to the value −5 dB of the reflection coefficient, the efficiency varies between the values 0.4 and 0.8, which is a good result for a dielectric antenna.

The antenna component and antenna according to the invention has been described above. Their implementations can deviate from the presented ones in the details. The shape of the conductive pattern of the radiator as well as the shape of the substrate can naturally vary. For example the first portion of the radiating element can be located on the front surface of the substrate and the second portion on the back surface. The inventive idea may be applied in different ways within the limits set by the independent claim 1.

1.-14. (canceled)

15. An antenna component, comprising:
an elongated substrate having a first end and a second end, an upper surface, a lower surface, a first side surface, and a second side surface;
a first head surface and a second head surface corresponding to the first and the second end respectively; and
a radiating element comprising:
a first portion extending from the first end to the second end of the substrate;
a second portion extending from the second end to the first end of the substrate; and
a feed point (FP) adapted to be connected to a feed conductor (FC) of the antenna;
wherein:
the first and the second portion of the radiating element are galvanically coupled to each other both proximate the first end and proximate the second end of the substrate thereby forming a loop structure enveloping the substrate;
and a width (w1) of at least a portion of said first portion is at most half of a width (w2) of at least a portion of the second portion.

16. The antenna component of claim 15, wherein:
the first portion and the second portion are disposed on opposing surfaces; and
coupling proximate the first end is effected via a third portion disposed at least partially on the first head surface; and
coupling proximate the second end is effected via a fourth portion disposed at least partially on the second head surface.

17. The antenna component of claim 15, wherein the first portion is disposed on the lower surface, and the second portion is disposed at least partially on the upper surface and at least partially on the first side surface.

18. The antenna component of claim 15, wherein:
the second portion is configured to cover substantially the width of the upper surface proximate the first end and at least a portion of the width of the upper surface proximate the second end; and
the second portion is further disposed on a side surface and is configured to cover a majority portion of the width of the side surface proximate the second end; and
the first portion is configured to form a pattern on the lower surface so that a segment of the line between the first and second portion in the plane of cross section of the component is oblique in respect of the vertical direction, excluding the center of the component.

19. The antenna component of claim 15, wherein the first and the second portion are disposed on a first and a second longitudinal surfaces of the substrate; wherein the first and the second longitudinal surfaces share a common edge.

20. The antenna component of claim 15, wherein:
the first and second portion are configured to be galvanically coupled to each other via at least a first conductor structure disposed on one of the first or the second side surface proximate an end of the substrate; and
the head surface proximate the end is free from conductive coating.

21. The antenna component of claim 15, wherein the feed point is disposed proximate one of the first or the second ends.

22. The antenna component of claim 15, wherein the feed point is disposed on the lower surface substantially proximate a mid-point of a lateral edge of the lower surface.

23. The antenna component of claim 22, wherein the feed point is coupled to the second portion via a conductor strip disposed substantially on one of the first or the second side surfaces.

24. The antenna component of claim 22, wherein the feed point is disposed on the first portion.

25. The antenna component of claim 15, wherein the substrate comprises a ceramic material.

26. An antenna for use in a portable radio device, the device comprising a ground plane and a feed port, the antenna comprising:
a dielectric substrate comprising a first and a second dimension, a first and a second end, and a plurality of surfaces; and
a radiating element disposed on the substrate, the radiating element comprising:
a first portion having a first width and extending substantially from the first end to the second end;
a second portion having a second width and extending substantially from the second end to the first end; and
a feed point configured for coupling to the feed port;
wherein:
the first end and the second end are disposed substantially opposite from each other;
the first portion is coupled to the second portion via a first coupling structure disposed proximate the first end, and via a second coupling structure disposed proximate the second end; and
the first width is configured to be less than one half of the second width.

27. The antenna of claim 26, wherein:
the first dimension is substantially perpendicular to the second dimension; and
the first dimension is greater than the second dimension.

28. The antenna of claim 27, wherein the first portion is disposed on a first surface, and the second portion is disposed at least partially on a second surface, the first surface substantially opposing the second surface.

29. The antenna of claim 28, wherein the second portion is disposed at least partially on a third surface, the second surface and the third surface having a common edge, the common edge being substantially parallel with the first dimension.

30. The antenna of claim 29, wherein:
the first coupling structure comprises a third portion disposed at least partially on the fifth surface; and
the second coupling structure comprises a fourth portion disposed at least partially on the sixth surface, the fifth surface substantially opposing the sixth surface.

31. The antenna according to claim 30, wherein:
the fifth surface and the first surface have a first common edge; and
the sixth surface and the first surface having a second common edge.

32. The antenna of claim 29, wherein:
the second portion is configured to cover substantially the width of the second surface proximate the first end and at least a portion of the width of the second surface proximate the second end; and
the second portion is further configured to cover a majority portion of the width of the third surface proximate the second end; and
the first portion comprises a plurality of segments arranged to form at least a portion of an S-curve pattern, wherein at least one of said plurality of segments is disposed substantially diagonally.

33. The antenna of claim 27, wherein:
the second portion is disposed on a second surface; and
the first portion is disposed on a third surface, the third and the second surfaces sharing a common edge, the common edge being substantially parallel to the first dimension.

34. The antenna of claim 27, wherein:
the first coupling structure is disposed on a fourth surface; and
the fifth surface proximate the first end is substantially free from conductive coating.

35. The antenna of claim 27, wherein the feed point is disposed proximate one of the first end or the second end.

36. The antenna of claim 28, wherein the feed point is disposed on the first surface substantially proximate a mid-point of a first edge, the first edge being substantially parallel to the first dimension.

37. The antenna of claim 36, wherein the feed point is coupled to the second portion via a conductor strip disposed on either one of a third surface or a fourth surface, the third and the fourth surfaces being substantially perpendicular to the first surface.

38. The antenna of claim 36, wherein the feed point is disposed on the first portion.

39. The antenna of claim 27, wherein the ground plane is disposed a first predetermined distance away from the substrate along at least a portion of a first edge of a first surface, the first edge being substantially parallel to the first dimension.

40. The antenna of claim 39, wherein the ground plane is disposed a second predetermined distance away from the substrate along at least a portion of a second edge of the first surface, the second edge being substantially perpendicular to the first edge.

41. The antenna of claim 27, further comprising a matching element coupled between the feed point and the ground plane.

42. An antenna for use in a portable radio device, the device comprising a ground plane and a feed port, the antenna comprising:
an at least partly dielectric substrate comprising a first and a second end, and a plurality of surfaces; and
a radiating element disposed substantially on the substrate, the radiating element comprising:
a first portion having a first width and extending substantially from the first end to the second end;
a second portion having a second width and extending substantially from the second end to the first end; and
a feed point configured for coupling to the feed port;
wherein the first portion is coupled to the second portion via a first coupling structure disposed proximate the first end and via a second coupling structure disposed proximate the second end.

43. The antenna of claim 42, wherein:
the substrate comprises a first dimension and a substantially perpendicular second dimension; and
the first dimension is greater than the second dimension.

44. The antenna of claim 43, wherein the first portion is disposed on a first surface, and the second portion is disposed at least partially on a second surface, the first surface substantially opposing the second surface.

45. The antenna according to claim 44, wherein the second portion is disposed at least partially on a third surface, the second surface and the third surface having a common edge, the edge being substantially parallel with the first dimension.
